(19) United States
(12) Patent Application Publication
(10) Pub. No.: US 2008/0209443 A1
(43) Pub. Date: Aug. 28, 2008

(54) APPARATUS AND METHOD FOR DISPLAYING PROCESS OPERATION

(76) Inventor: KAZUAKI SUZUKI, Tokyo (JP)

Correspondence Address: NEC CORPORATION OF AMERICA, 6535 N. STATE HWY 161, IRVING, TX, 75039, US

(21) Appl. No.: 12/037,464

(22) Filed: Feb. 26, 2008

(30) Foreign Application Priority Data
Feb. 27, 2007 (JP) 2007-047035

(51) Int. Cl. G06F 9/46

(52) U.S. Cl. 719/318

(57) ABSTRACT

A process operation display apparatus includes a storage section configured to store a process control table in which a set of a process ID of a process and a user ID of a user is written. An event trace data outputting section detects events of about execution start and execution end of an executed process and generates an event trace data based on a process ID of the executed process and the detected events. A user ID added event trace data generating section generates a user ID added event trace data in which a set of the event trace data and the user ID corresponding to the process ID contained in the event trace data is written, by referring to the process control table based on the process ID. A display control section displays a set of the process ID of the executed process and the user ID of the user who instructed the execution of the executed process on a display unit based on the user ID added event trace data.

This Patent Application is based on Japanese Patent Application No. 2007-047035 filed Feb. 27, 2007. The disclosure thereof is incorporated herein by reference.

### TECHNICAL FIELD

The present invention relates to a process operation display technique for displaying an operation status of a process executed on a computer, and especially relates to an apparatus and method for displaying a process operation, in which a user who has instructed execution of a process can be determined.

### BACKGROUND ART

Various types of process operation display apparatus are known to display an operation status of a process executed on a computer. In the process operation display apparatuses described in Japanese Patent Application publications (JP-P2003-157185A and JP-P2004-5198A: first and second examples), an operation status of a process executed on a computer is displayed as follows. Probes for detecting a process switching event are embedded in predetermined points in an operating system of the computer (a probe for detecting Resum of a process and a probe for detecting Save of the process are embedded). Respective probes output event trace data including an event type (Save or Resum) and a process ID of the Saved or Resumed process. This event trace data is recorded in a storage unit in an order of occurrence, and a display unit displays respective executed processes in the order of execution based on stored contents of the storage unit. In addition, in the first and second example, probes for detecting an inter-process communication event are also embedded in predetermined points of the operating system, thus the inter-process communication can also be displayed.

According to the first and second examples, a process operation status can be understood easily since processes executed on a computer can be displayed can be arranged in time-series and inter-process communication can be performed between respective processes. However, since the process operation display apparatus described in the first and second examples intends to analyze the performance of a computer, information regarding a user who executed the process is not displayed at all. For this reason, it cannot be determined who executed the process depending on the conventional technique described in Patent document 1. In addition, the information regarding the user who has executed the process is not displayed at all also in an operation display apparatus of a computer similar to the first and second examples such as the Linux Trace Tool and the Linux Kernel State Tracer.

### SUMMARY

Therefore, an object of the present invention is to provide a technique for easy determination of who executed which process.

In a first exemplary aspect of the present invention, a process operation display apparatus includes a storage section configured to store a process control table in which a set of a process ID of a process and a user ID of a user is written; an event trace data outputting section configured to detect events of about execution start and execution end of an executed process and to generates an event trace data based on a process ID of the executed process and the detected events; a user ID added event trace data generating section configured to generate a user ID added event trace data in which a set of the event trace data and the user ID corresponding to the process ID contained in the event trace data is written, by referring to the process control table based on the process ID; and a display control section configured to display a set of the process ID of the executed process and the user ID of the user who instructed the execution of the executed process on a display unit based on the user ID added event trace data.

In another exemplary aspect of the present invention, a process operation display method includes detecting events of execution start and execution end of an executed process to generate an event trace data based on a process ID of the executed process and the detected events; generating a user ID added event trace data in which a set of the event trace data and a user ID corresponding to the process ID contained in the event trace data is written, by referring to a process control table based on the process ID, wherein a set of a process ID of a process and a user ID of a user is written in the process control table; and displaying a set of the process ID of a executed process and the user ID of the user who instructed the execution of the executed process on a display unit based on a user ID added event trace data in which a set of a process ID of a process and a user ID of a user is written.

In another exemplary aspect of the present invention, a computer-readable software medium in which a program is recorded for realizing a process operation display method is provided. The process operation display method includes detecting events of execution start and execution end of an executed process to generate an event trace data based on a process ID of the executed process and the detected events; generating a user ID added event trace data in which a set of the event trace data and a user ID corresponding to the process ID contained in the event trace data is written, by referring to a process control table based on the process ID, wherein a set of a process ID of a process and a user ID of a user is written in the process control table; and displaying a set of the process ID of a executed process and the user ID of the user who instructed the execution of the executed process on a display unit based on a user ID added event trace data in which a set of a process ID of a process and a user ID of a user is written.

According to the present invention, it can be determined who executed which process.

### BRIEF DESCRIPTION OF THE DRAWINGS

The above and other objects, advantages and features of the present invention will be more apparent from the following description of certain exemplary embodiments taken in conjunction with the accompanying drawings, in which:

FIG. 1 is a block diagram showing the configuration of the process operation display apparatus according to a first exemplary embodiment of the present invention;

FIG. 2 is a diagram showing an example of a content of a process management table;

FIG. 3 is a diagram showing an example of a user ID added event trace data;

FIG. 4 is a diagram showing an example of a content of a user ID/user name correspondence table;

FIG. 5 is a diagram showing an example of display by a display control section;

FIG. 6 is a flowchart showing an operation of a user ID added event trace data generating section;

FIG. 7 is a flowchart showing an operation of a converting section; and

FIG. 8 a view showing an example of a user name added event trace data.

### EXEMPLARY EMBODIMENTS

Hereinafter, a process operation display apparatus according to exemplary embodiments of the present invention will be described in detail with reference to the attached drawings.

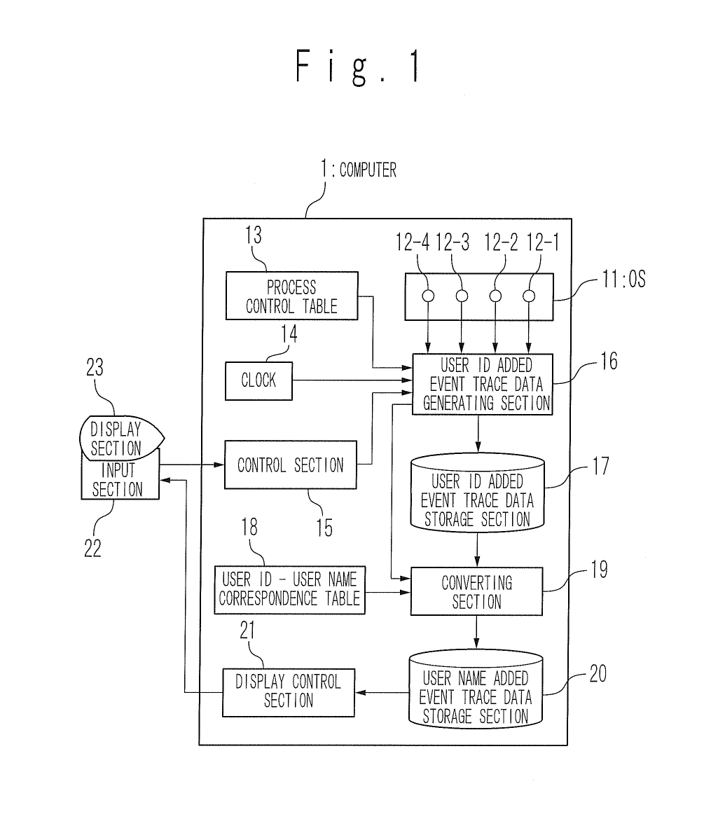

FIG. 1 is a block diagram showing the configuration of the process operation display apparatus according to a first exemplary embodiment of the present invention. Referring to FIG. 1, the process operation display apparatus according to the first exemplary embodiment includes probes 12-1 to 12-4 embedded in an operating system (OS) 11 executed on a computer 1, a process management table 13, a clock 14, a control section 15, a user ID added event trace data generating section 16, a user ID added event trace data storage section 17, a user ID/user name correspondence table 18, a converting section 19, a user name added event trace data storage section 20, a display control section 21, an input section 22 such as a keyboard, a display section 23 such as an LCD display.

The probes 12-1 and 12-2 are probes for detecting a process switching event. The probe 12-1 outputs an event trace data including an event type “Resum of process” and “process ID of resumed process” when the probe 12-1 is executed. The probe 12-2 outputs an event trace data including an event type “Save of process” and “process ID of saved process” when the probe 12-2 is executed. The probes 12-3 and 12-4 are probes for detecting an inter-process communication event. The probe 12-3 outputs an event trace data including an event type “Send (transmission in inter-process communication)” and “Communication path number” when the probe 12-3 is executed. The probe 12-4 outputs an event trace data including an event type “Receive (reception in the inter-process communication)” and “Communication path number” when the probe 12-4 is executed. It should be noted that a format of the event trace data outputted from the respective probes 12-1 to 12-4 is not limited to an example described above, and any format may be allowed if being able to characterize an operation of a process. Also, the type of the probes is not limited to the example described above, and probes embedded in an application program may be used.

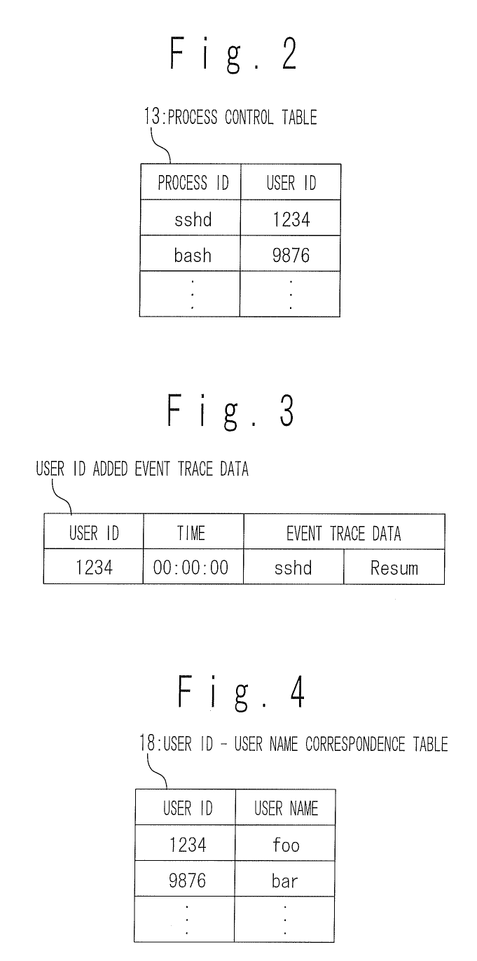

A process ID and a user ID of a user who instructed execution of a process having the process ID are registered in the process management table 13. FIG. 2 shows a contents example of the process management table 13. In FIG. 2, a user having the user ID of “1234” instructs execution of a process having the process ID of “sshd” and a user having the user ID of “9876” instructs execution of a process having the process ID of “bash”.

The clock 14 displays current time.

The control section 15 issues a start instruction to the generating section 16 in response to an instruction of start of recording of event trace data from a user via the input section 22 and issues an end instruction to the generating section 16 in response to an instruction of end of the recording.

The user ID added event trace data generating section 16 includes following functions.

When the event trace data including a process ID is received, current time is received from the clock 14, and a user ID related to a process ID included in the event trace data mentioned above is searched from the process management table 13. Thus, a user ID added event trace data including the event trace data, the current time, and the user ID is generated and stored in the storage section 17. In FIG. 3, an example of the user ID added event trace data is shown. In the example, a process having the process ID of “sshd” is “resumed” by a user having the user ID of “1234” at time “00:00:00”.

When the event trace data not including the process ID is received, the current time is received from the clock 14, and the event trace data related to the current time is stored into the storage section 17.

When the end instruction is received from the control section 15, the converting section 19 is started.

A user ID and a user name of a user having the user ID are registered in the user ID/user name correspondence table 18. That is to say, the user ID/user name correspondence table 18 is a table for relating a user ID having an expression form which can be read by a machine to a user name having an expression form which can be read by human being. FIG. 4 is a diagram showing a contents example of the user ID/user name correspondence table 18. In the example, a user name of a user specified by the user ID of “1234” is “foo” and a user name of a user specified by the user ID of “9876” is “bar”.

The converting section 19 sequentially receives data stored in the storage section 17, replaces a user ID in the user ID added event trace data by a user name corresponding to he user ID by referring to the user ID/user name correspondence table 18 when the received data is the user ID added event trace data, and stores the replaced data (user name added event trace data) in the event storage section 20. In addition, when the read data is not the user ID added event trace data, the data is directly stored in the storage section 20.

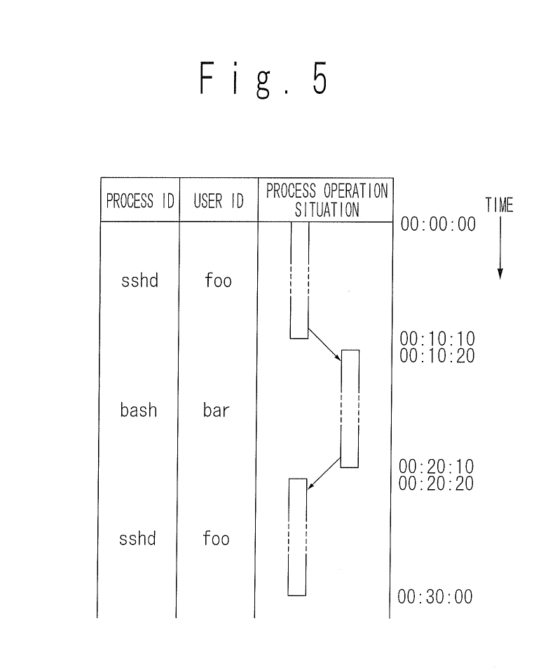

The display control section 21 displays a set of a process name and a user name who instructed execution of the process on the display section 23 based on contents stored in the storage section 20 and displays an operation status of the process. In FIG. 5 is a diagram showing a display example by the display control section 21. In this example, processes having the process ID of “sshd” instruction by the user having the user name of “foo” and the process ID of “bash” instructed by the user having the user name of “bar” performs the inter-process communication. In addition, in this example, times when the process is resumed and saved are displayed.

It should be noted that the control section 15, the generating section 16, the converting section 19, and the display control section 21 can be realized by a CPU (computer) and a program. In such a case, following steps are taken for an example. A disk, a semiconductor memory, and other recording media are prepared which can store programs for allowing the CPU to operate as the control section 15, the generating section 16, the converting section 19, and the display control section 21, and the above-mentioned programs are executed by the CPU. The CPU realizes the control section 15, the generating section 16, the converting section 19, and the display control section 21 on itself by controlling its own operation in accordance with the read programs.

Next, an operation of the process operation display apparatus in the first exemplary embodiment will be described in detail. The respective probes 12-1 to 12-4 embedded in the operating system 11 output event trace data when they are executed, respectively. In the first exemplary embodiment, the probe 12-1 outputs the event trace data including an event type of “Resum” and “process ID of resumed process”, and the probe 12-2 outputs the event trace data including an event type of “Save” and “process ID of saved process”. Further, the probe 12-3 outputs the event trace data including an event type of “send” and “communication path number”, and the probe 12-4 outputs the event trace data including an event type of “Receive” and “communication path number”.

When recording of the event trace data is started, a user issues a recording start instruction to the control section 15 from the input section 22. Thus, the control section 15 outputs a start instruction to the generating section 16.

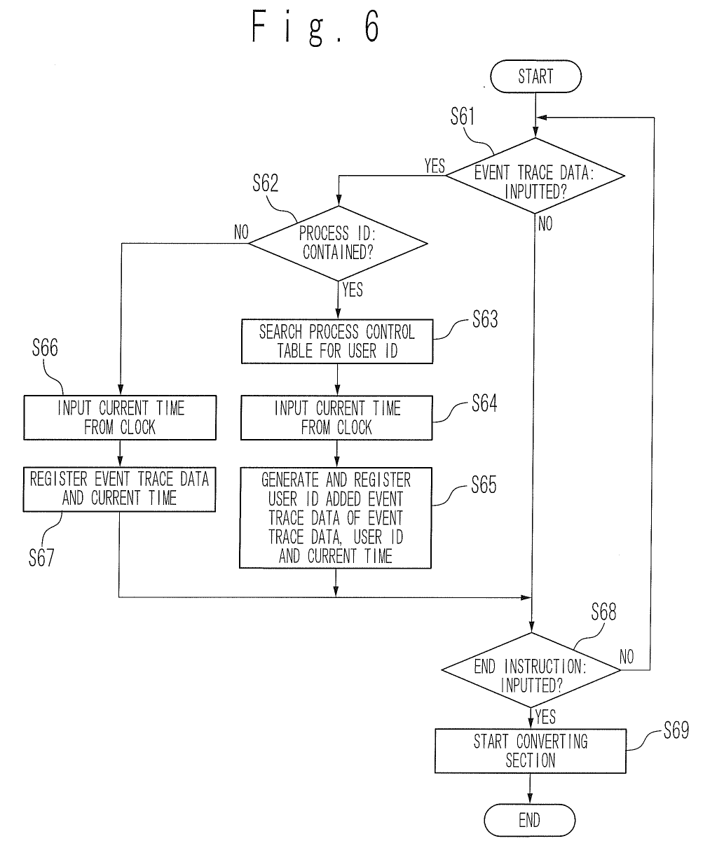

The generating section 16 starts a process shown in a flowchart of FIG. 6 in response to the start instruction. After the start, when the event trace data is received from the probes 12-1 to 12-4 (YES in step S61), the generating section 16 determines whether or not a process ID is included in the event trace data (step S62). When it is determined that the process ID is included (YES in step S62), a user ID is searched from the process management table 13 based on the aforementioned process ID (step S63). Moreover, current time is received from the clock 14 (step S64). After that, a user ID added event trace data including the event trace data, the user ID searched at step S63, and the current time received at step S64 is generated and registered in the storage section 17 (step S65). For example, it is assumed that the process ID included in the event trace data is “sshd”, the current time is “00:00:00”, and the content of the process management table 13 is as shown in FIG. 2, the user ID added event trace data shown in FIG. 3 is generated and registered in the storage section 17.

On the other hand, when it is determined that the process ID is not included (NO at step S62), current time is received from the clock 14 (step S66). After that, the event trace data and the current time received at step S66 are registered in the storage section 17 (step S67).

The generating section 16 performs the process described above every time the event trace data is received.

When the recording of the event trace data is ended, the user issues a recording end instruction to the control section 15 from the input section 22 to end the recording of the event trace data. Thus, the control section 15 outputs the end instruction to the generating section 16. When the end instruction is received from the control section 15, the generating section 16 ends the process after starting the converting section 19 (step S69).

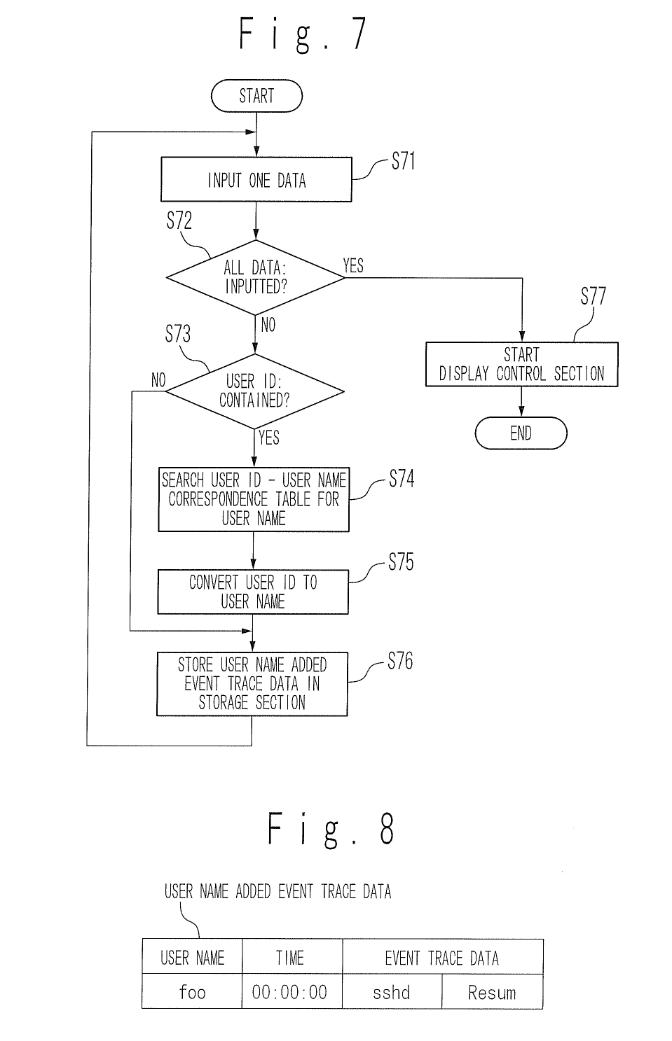

When being started, as shown in a flowchart of FIG. 7, the converting section 19 receives one piece of the event trace data registered in the storage section 17 (step S71) and determines whether or not a user ID is included in the event trace data (step S73). That is to say, it is determined whether or not the received event trace data is the user ID added event trace data.

When it is determined that the user ID is included (step S73 is YES), a user name related to the above mentioned user ID is searched from the user ID/user name correspondence table 18 (step S74). Moreover, the user ID in the received event trace data is replaced by the user name searched at step S74 (step S75), and the replaced user ID added event trace data is registered in the storage section 20 (step S76). For example, when the user ID added event trace data shown in FIG. 2 is received, the user ID added event trace data shown in FIG. 8 is generated.

On the other hand, when it is determined that the user ID is not included (NO at step S73), the data received at step S71 is directly registered in the storage section 20 (step S76).

The converting section 19 repeats the aforementioned process until all the data which are not received yet are received. When all the data are received (step S72 is YES), the converting section 19 starts the display control section 21 (step S77), and after that, ends the process.

When being started, the display control section 21 performs a display shown in FIG. 5 on the display section 23 based on the storage contents of the storage section 20. That is to say, a process ID of the executed process and a user name who instructed execution of the process are displayed as an indivisible pair and an operation status of the process is displayed.

It should be noted that in the above description, the display control section 21 displays the indivisible pair of a process ID of the executed process and a user name who instructed execution of the process and the operation status of the process based on the storage contents of the storage section 20. However, the display control section 21 may display the indivisible pair of a process ID of the executed process and a user ID of a user who instructed execution of the process and the operation status of the process based on the storage contents of the storage section 17. In this case, the converting section 19 and the storage section 20 are unnecessary.

According to the present exemplary embodiments, it can be determined who instructed execution of which process. Therefore, the present invention is effective to a computer system in businesses in case that it is required to manage who instructed execution of which process.

What is claimed is:

1. A process operation display apparatus comprising:
a storage section configured to store a process control table in which a set of a process ID of a process and a user ID of a user is written;
an event trace data outputting section configured to detect events of about execution start and execution end of an executed process and to generate an event trace data based on a process ID of the executed process and the detected events;
a user ID added event trace data generating section configured to generate a user ID added event trace data in which a set of said event trace data and the user ID corresponding to the process ID contained in the event trace data is written, by referring to said process control table based on the process ID; and
a display control section configured to display a set of the process ID of the executed process and the user ID of the user who instructed the execution of the executed process on a display unit based on the user ID added event trace data.

2. The process operation display apparatus according to claim 1, wherein said storage section is configured to store a correspondence table in which a set of a user ID and a user name of the user is written, and
said process operation display apparatus further comprises:
a converting section configured to convert the user ID of the user ID added event trace data into the user name to produce a user name added event trance data by referring to said correspondence table,
wherein said display control section displays the set of the user name and the process ID on said display unit based on the user name added event trace data.

3. A process operation display method comprising:
detecting events of execution start and execution end of an executed process to generate an event trace data based on a process ID of the executed process and the detected events;
generating a user ID added event trace data in which a set of said event trace data and a user ID corresponding to the process ID contained in the event trace data is written, by referring to a process control table based on the process ID, wherein a set of a process ID of a process and a user ID of a user is written in said process control table; and
displaying a set of the process ID of a executed process and the user ID of the user who instructed the execution of the executed process on a display unit based on a user ID added event trace data in which a set of a process ID of a process and a user ID of a user is written.

4. The process operation display method according to claim 3, further comprising:
converting the user ID of the user ID added event trace data into the user name to produce a user name added event trance data by referring to a correspondence table, in which a set of the user ID and a user name corresponding to the user is recorded, based on the user ID,
wherein said displaying comprises:
displaying the set of the user name and the process ID on said display unit based on the user name added event trace data.

5. A computer-readable software medium in which a program is recorded for realizing a process operation display method which comprises:
detecting events of execution start and execution end of an executed process to generate an event trace data based on a process ID of the executed process and the detected events;
generating a user ID added event trace data in which a set of said event trace data and a user ID corresponding to the process ID contained in the event trace data is written, by referring to a process control table based on the process ID, wherein a set of a process ID of a process and a user ID of a user is written in said process control table; and
displaying a set of the process ID of a executed process and the user ID of the user who instructed the execution of the executed process on a display unit based on a user ID added event trace data in which a set of a process ID of a process and a user ID of a user is written.

6. The computer-readable software medium according to claim 5, wherein said process operation display method further comprises:
converting the user ID of the user ID added event trace data into the user name to produce a user name added event trance data by referring to a correspondence table, in which a set of the user ID and a user name corresponding to the user is recorded, based on the user ID,
wherein said displaying comprises:
displaying the set of the user name and the process ID on said display unit based on the user name added event trace data.
